(19) United States
(12) Patent Application Publication
(10) Pub. No.: US 2012/0303461 A1
(43) Pub. Date: Nov. 29, 2012

(54) SYSTEM AND METHOD TO CREATE ADVERTISING IMAGE

(75) Inventors: Jim A. Varga, Uniontown, OH (US); Tony N. Priscaro, Rock Hill, SC (US)

(73) Assignee: SOCIAL FAN WRAP, LLC, Hartville, OH (US)

(21) Appl. No.: 13/478,075

(22) Filed: May 22, 2012

Related U.S. Application Data
(60) Provisional application No. 61/489,134, filed on May 23, 2011.

(51) Int. Cl. G06Q 30/02

(52) U.S. Cl. 705/14.69; 705/14.72

(57) ABSTRACT

A method for creating an advertising image is disclosed. In at least one embodiment, the method includes soliciting a plurality of users to each provide at least one image from a social networking site; assembling a mosaic from images provided by the users into an advertising image; and attaching the advertising image to a three-dimensional object. In at least one alternative embodiment, the method includes soliciting a plurality of users to each provide at least one image from a social networking site; collecting a payment from each user submitting an image; assembling a mosaic from images provided by the users into an advertising image; arranging the advertising image to be placed upon a vehicle participating in a motor sports event; and attaching the advertising image to the vehicle.

### CROSS-REFERENCE TO RELATED APPLICATION(S)

The present non-provisional patent application claims the benefit of priority of U.S. Provisional Patent Application No. 61/489,134, which is entitled “ONLINE PROFILE IMAGES FROM ANY SOCIAL NETWORK USED TO MAKE AN ADVERTISING IMAGE”, which was filed on May 23, 2011, and which is incorporated in full by reference herein.

### FIELD OF THE INVENTION

The technology described herein relates generally to systems and methods for advertising. More specifically, this technology relates to creating advertising and promotional images. Furthermore this technology relates to systems and methods for enhancing promotional activities.

### BACKGROUND OF THE INVENTION

Organizations and companies are always trying to find innovative and interesting ways to promote their goods and services. As consumers are continually exposed to advertising and promotional items, advertisers must continually develop new and innovative techniques of attracting the attention of consumers.

Related issued utility patents and patent application publications known in the art include the following:

U.S. Patent Application Publication No. 2008/0177557 filed by Saul and published on Jul. 24, 2008, which is herein incorporated by reference in its entirety, discloses a promotional system. A method for promoting a matter in connection with a motor sports event comprises: soliciting from a plurality of participants at least one image associated with each of the participants; collecting a fee from each participant submitting, or endorsing, an image in response to the solicitation; assembling a mosaic from images provided by, or endorsed by, the participants; arranging the mosaic upon a vehicle that will compete in the motor sports event; attaching the mosaic to the vehicle; and facilitating provision of affirmation to the participants of the vehicle's participation in the motor sports event.

U.S. Patent Application Publication No. 2008/0154944 filed by Erdos et al. and published on Jun. 26, 2008, which is herein incorporated by reference in its entirety, discloses an automated online ecommerce system for sponsorship acquisition and retention. In a computer environment, the present invention is a method for allowing a user to quickly and effectively purchase a sponsorship on an Internet website, comprising choosing a location on a virtual object having a visually concealed continuous interconnected net of a particular shape on the website, wherein the virtual object is a virtual representation of an actual physical object, entering a message in the location, choosing an event associated with the physical object, creating a master file with the location, message event information, electronically sending the master file to a service provider of the physical object and automatically creating and printing a paint scheme by the service provider on a medium configured to wrap around the physical object, wherein the paint scheme is a tone-on-tone paint scheme configured to blend with an overall paint scheme of the object.

U.S. Patent Application Publication No. 2008/0133258 filed by Kontogouris and published on Jun. 5, 2008, which is herein incorporated by reference in its entirety, discloses a method of fund raising for a predetermined cause utilizing a photo-mosaic composition. The method of fund raising for a predetermined cause utilizes a photo-mosaic composition with an appearance approximating a target image that is representative of the cause, the target image being compiled from source images contributed by participant individuals wishful of advancing the cause, wherein a web site is set to host a clickable icon file of the photo-mosaic composition associated with a database of participant profiles that is searchable through an incorporated search engine. The web site allows networking of participant individuals. The photo-mosaic composition is rendered through available rendering software in predetermined time intervals and periodical printouts thereof are produced to provide outdoor exhibits to be displayed in public, the scope of advancement of the predetermined cause and effective fundraising being achieved through the multiplier effect produced by the combination of outdoor and electronic promotional activities.

However, none of these prior art references disclose using online profile images from any social networking site to assemble a mosaic into an advertising image.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### SUMMARY OF THE INVENTION

In various exemplary embodiments, the technology described herein provides systems and methods for creating advertising and promotional images and for enhancing promotional activities.

In at least one exemplary embodiment, the technology described herein provides a method for creating an advertising image. The method for creating an advertising image includes: soliciting a plurality of users to each provide at least one image from a social networking site; assembling a mosaic from images provided by the plurality of users into an advertising image; and attaching the advertising image to a three-dimensional object.

The method for creating an advertising image also can include: accessing, by a user, a host website where the user can select the three-dimensional object to sponsor; and selecting, by the user, the three-dimensional object to sponsor.

The method for creating an advertising image further can include selecting, by the user, an advertising image to sponsor on the three-dimensional object.

The method for creating an advertising image also can include selecting, by the user, a number of advertising images greater than one to submit to sponsor on the three-dimensional object.

The method for creating an advertising image further can include remitting the payment, by the user, for the sponsorship.

The method for creating an advertising image also can include uploading, by the user, at least one image from a social networking website to the host website.

In at least one embodiment, the three-dimensional object comprises a racecar.

In at least one embodiment, the three-dimensional object comprises a billboard.

In at least one embodiment of this method, use of the at least one image from a social networking site from the plurality of users creates an advertising platform based on social media, and wherein the resulting mosaic advertising image attached to the three-dimensional object provides actual participation by the user in the advertisement.

The method for creating an advertising image further can include providing the user a means at the host website by which the advertising image selected by the user is searchable within the mosaic and viewable online by the user at the host website.

In yet another exemplary embodiment, the technology described herein provides a method for creating an advertising image. The method for creating an advertising image in this embodiment includes: soliciting a plurality of users to each provide at least one image from a social networking site; collecting a payment from each user submitting an image; assembling a mosaic from images provided by the users into an advertising image; arranging the advertising image to be placed upon a vehicle participating in the motor sports event; and attaching the advertising image to the vehicle.

The method for creating an advertising image also can include: accessing, by a user, a host website where the user can select the three-dimensional object to sponsor; and selecting, by the user, the three-dimensional object to sponsor.

The method for creating an advertising image further can include selecting, by the user, an advertising image to sponsor on the three-dimensional object.

The method for creating an advertising image also can include selecting, by the user, a number of advertising images greater than one to submit to sponsor on the three-dimensional object.

The method for creating an advertising image further can include remitting the payment, by the user, for the sponsorship.

The method for creating an advertising image also can include uploading, by the user, at least one image from a social networking website to the host website.

In at least one embodiment of this method, use of the at least one image from a social networking site from the plurality of users creates an advertising platform based on social media, and wherein the resulting mosaic advertising image attached to the three-dimensional object provides actual participation by the user in the advertisement.

The method for creating an advertising image further can include providing the user a means at the host website by which the advertising image selected by the user is searchable within the mosaic and viewable online by the user at the host website.

In still yet another exemplary embodiment, the technology described herein provides a method for creating an advertising image. The method for creating an advertising image includes: soliciting a plurality of users to each provide at least one image from a social networking site; collecting a payment from each user submitting an image; assembling a mosaic from images provided by the users into an advertising image; arranging the advertising image to be placed upon a vehicle participating in the motor sports event; attaching the advertising image to the vehicle; accessing, by a user, a host website where the user can select the three-dimensional object to sponsor; selecting, by the user, the three-dimensional object to sponsor; selecting, by the user, an advertising image to sponsor on the three-dimensional object; selecting, by the user, a number of advertising images greater than one to submit to sponsor on the three-dimensional object; remitting the payment, by the user, for the sponsorship; and uploading, by the user, at least one image from a social networking website to the host website. Use of the at least one image from a social networking site from the plurality of users creates an advertising platform based on social media, and wherein the resulting mosaic advertising image attached to the three-dimensional object provides actual participation by the user in the advertisement.

The method for creating an advertising image also can include providing the user a means at the host website by which the advertising image selected by the user is searchable within the mosaic and viewable online by the user at the host website.

Advantageously, the technology described herein provides systems and methods for creating advertising and promotional images and for enhancing promotional activities.

Thus, there has thus been outlined, rather broadly, the features of the present invention in order that the detailed description that follows may be better understood, and in order that the present contribution to the art may be better appreciated. There are additional features of the invention that will be described and which will form the subject matter of the claims. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed are for the purpose of description and should not be regarded as limiting.

As such, those skilled in the art will appreciate that the conception, upon which this disclosure is based, may readily be utilised as a basis for the designing of other structures, methods, and systems for carrying out the several purposes of the present invention. It is important, therefore, that the claims be regarded as including such equivalent constructions insofar as they do not depart from the spirit and scope of the present invention.

Additional aspects and advantages of the present invention will be apparent from the following detailed description of an exemplary embodiment which is illustrated in the accompanying drawings.

### BRIEF DESCRIPTION OF THE DRAWINGS

FIG. 1 is a flowchart for a method of creating an advertisement, according to an embodiment of the technology described herein;

FIG. 2 is a flowchart for a method of creating an advertisement, according to an embodiment of the technology described herein;

FIG. 3 is a flowchart for a method of creating an advertisement, according to an embodiment of the technology described herein;

FIG. 4 is a three-dimensional object with an advertising image, illustrating, in particular, an advertising image in the form of a mosaic of a multiplicity of images in a random or pre-defined configuration, according to an embodiment of the technology described herein;

FIG. 5 is an advertisement system, illustrating, in particular, a host website, a web or internet server, and a database, according to an embodiment of the technology described herein;

FIG. 6 is a three-dimensional object with an advertising image, illustrating, in particular, an advertising image in the form of a mosaic of a multiplicity of images in a random or pre-defined configuration, according to an embodiment of the technology described herein;

FIG. 7 is a close-up of the advertising image depicted in FIG. 6, illustrating, in particular, an advertising image in the form of a mosaic of a multiplicity of images in a random or pre-defined configuration, according to an embodiment of the technology described herein;

FIG. 8 is a view of an online means by which a user can view his or her image within the mosaic advertising image created, according to an embodiment of the technology described herein;

FIG. 9 is a view a user image within the mosaic advertising image created, upon entry of an e-mail address or other identifying criteria, according to an embodiment of the technology described herein;

FIG. 10 is a view of a billboard advertisement created with users images in a mosaic, according to an embodiment of the technology described herein; and

FIG. 11 is a view of a movie poster advertisement created with users images in a mosaic, according to an embodiment of the technology described herein.

### DETAILED DESCRIPTION

In various exemplary embodiments, the technology described herein provides systems and methods for creating advertising and promotional images and for enhancing promotional activities.

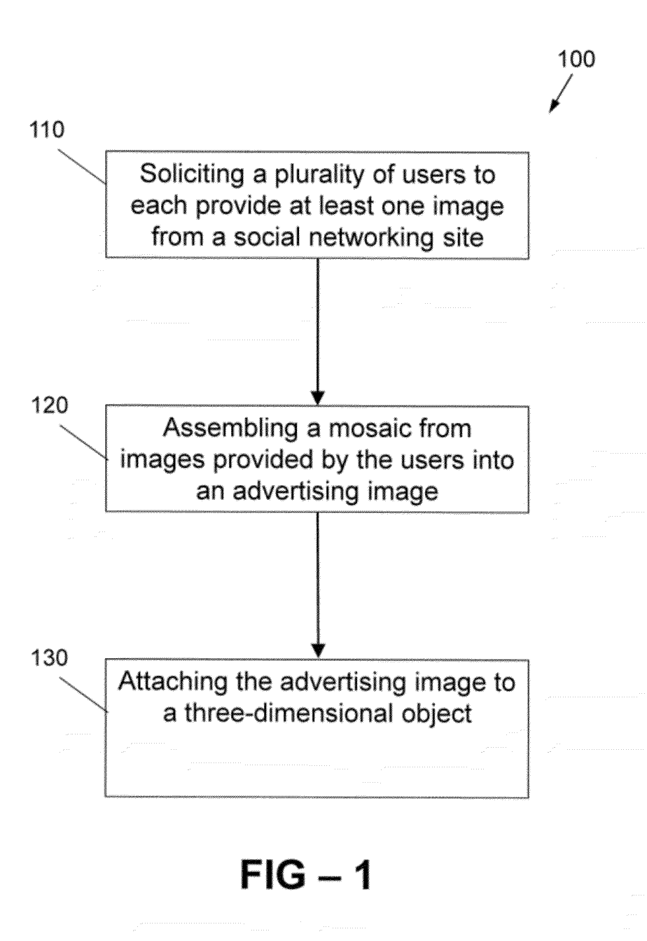

Referring now to the FIGS. 1 through 10, wherein the showings are for purposes of illustrating embodiments of the technology described herein only and not for purposes of limiting the same, and wherein like reference numerals are understood to refer to like components, FIG. 1 illustrates a method 100 of creating an advertising image for enhancing promotional activities.

In at least one embodiment, the method 100 includes the step 110 of soliciting a plurality of users to each provide at least one image from a social networking site. In some embodiments, a user can access a host website and upload one or more images from a social networking site. Hundreds if not thousands of social networking sites exist. The technology described herein utilises the popularity of such social networking websites and the willingness of their participants to share online, provide personal photos, work collectively on tasks, and so forth. By way of example, a user may access a host website and upload an image from Facebook or the like, in which the person is depicted, or an item of interest to the user is depicted in the photo.

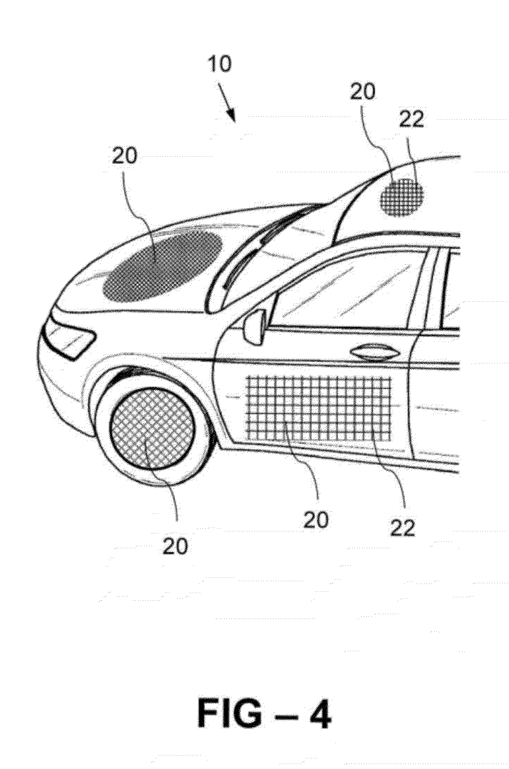

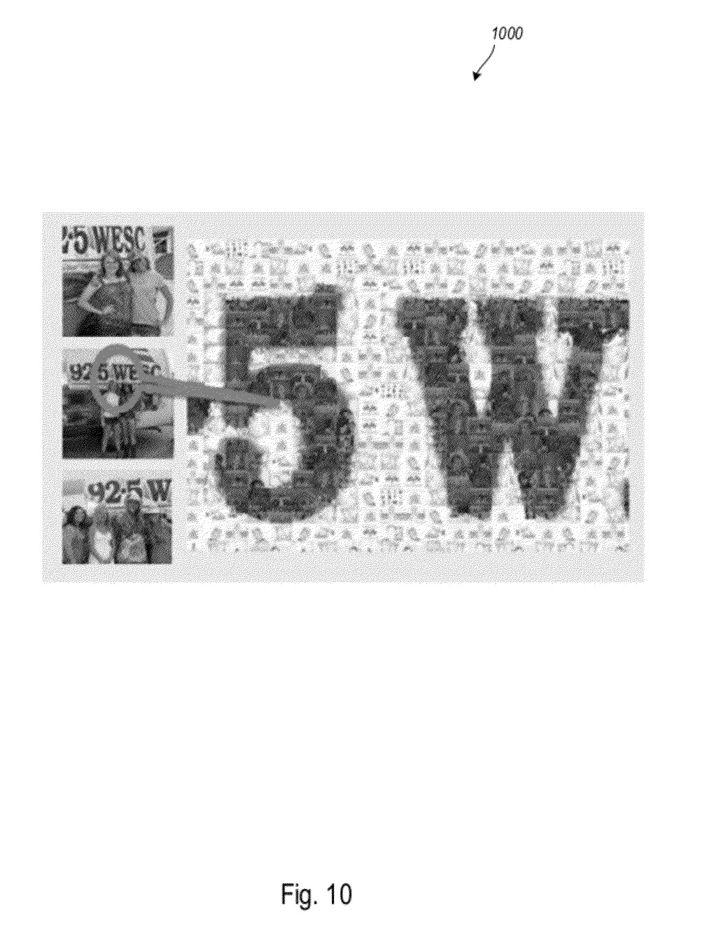

In at least one embodiment, the method 100 includes the step 120 of assembling or arranging a mosaic from images provided by the users into an advertising image. By way of example, adverting images 20 are depicted in FIG. 4, showing various advertisements and promotions on a racecar hood, wheel, door panel, and roof. Also by way of example, an advertising billboard 1000 is depicted in FIG. 10, made up of thousands of images from users through social networking sites and arranged into a mosaic advertising and promotion image.

In at least one embodiment, the method 100 includes the step 130 of attaching the advertising image to a three-dimensional object. By way of example, and as depicted specifically in FIGS. 4, 6, and 7 the three-dimensional object is a racecar 600. Also by way of example, and as depicted specifically in FIG. 10, the three-dimensional object is an advertising billboard 1000.

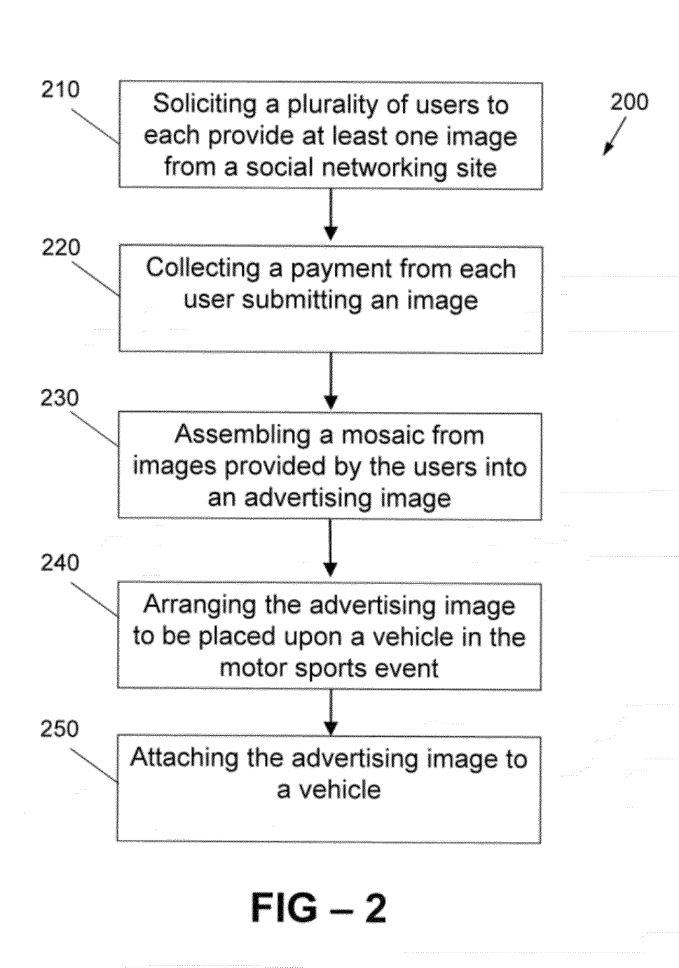

With reference to FIG. 2, an alternative method 200 of creating an advertising image is illustrated. In at least one embodiment, the method 200 includes the step 210 of soliciting a plurality of users to each provide at least one image from a social networking site.

In at least one embodiment, the method 200 includes the step 220 of collecting a payment from each user submitting an image. By way of example, payment can be made online in the form of a transfer, credit-card payment, of the like. The payment to an individual user may be much smaller than if a person, company, or organization solely purchased an advertisement. The mosaic image approach allows for thousands of participants to participate, and in at least one embodiment, allows the users to participate collectively and pay a much lower payment for the participation in the advertising and promotion. In at least one embodiment, the user is not limited to the number of images submitted, but pays based on each image submitted.

In at least one embodiment, the method 100 includes the step 230 of assembling or arranging a mosaic from images provided by the users into an advertising image. By way of example, adverting images 20 are depicted in FIG. 4, showing various advertisements and promotions on a racecar hood, wheel, door panel, and roof. Also by way of example, an advertising billboard 1000 is depicted in FIG. 10, made up of thousands of images from users through social networking sites and arranged into a mosaic advertising and promotion image.

In at least one embodiment, the method 100 includes the step 240 of arranging the advertising image to be placed upon a vehicle in the motor sports event. By way of example, and as depicted specifically in FIGS. 4, 6, and 7 the three-dimensional object is a racecar 600.

In at least one embodiment, the method 100 includes the step 250 of attaching the advertising image to a vehicle. By way of example, and as depicted specifically in FIGS. 4, 6, and 7 the three-dimensional object is a racecar 600.

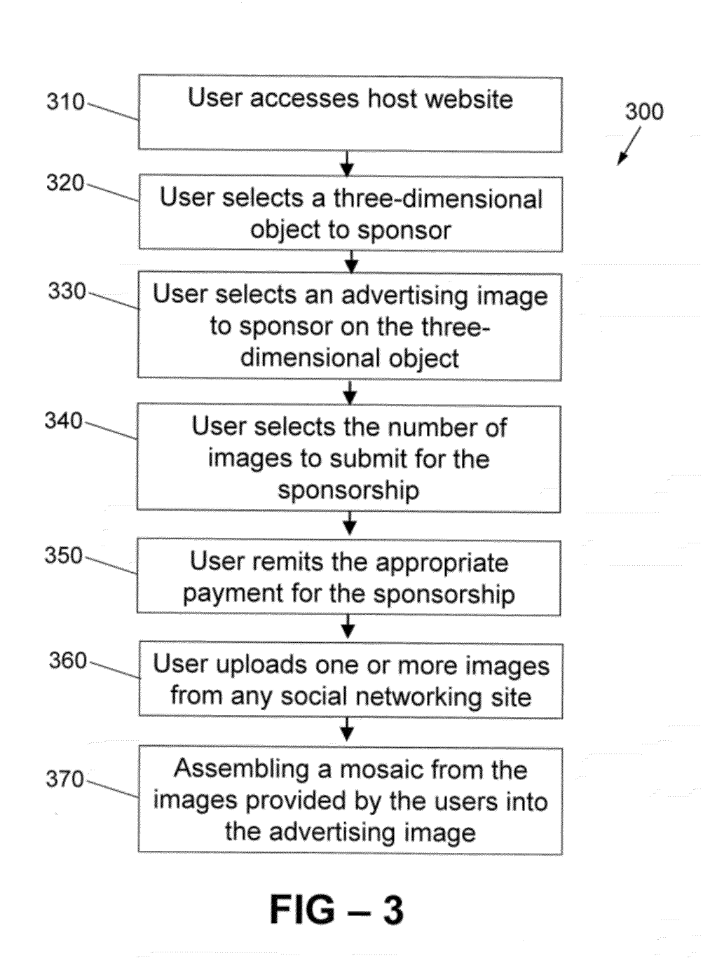

With reference to FIG. 3, a method 300 of creating an advertising image is illustrated. In at least one embodiment, the method 300 includes step 310 of a user accessing a host website. The host website can include the necessary software so the user can login, upload images, and pay a sponsorship fee.

In at least one embodiment, the method 300 includes the step 320 of the user selecting a three-dimensional object to sponsor. The three-dimensional object can be many different objects including, but not limited to, a race car, a stock car (including NASCAR), and other racing vehicles. In some embodiments, the user can select the specific location on the three-dimensional object for the one or more images.

In at least one embodiment, the method 300 includes step 330 of the user selecting an advertising image to sponsor on the three-dimensional object. The three-dimensional object can include one or more advertising images positioned on the object. In some embodiments, the user can select the specific location on the advertising image for the one or more images.

In at least one embodiment, the method 300 includes the step 340 of the user selecting the number of images to submit for the sponsorship. The user can select one or more images to submit or upload from any social networking site for the advertising image.

In at least one embodiment, the method 300 includes step 350 of the user remitting the appropriate payment for the sponsorship. The amount of payment can depend on various factors including, but not limited to, the number of images submitted by the user. the number of images in the advertising image, the size of the advertising image, the type of advertising image, the goods and services displayed in the advertising image, the type and size of the three-dimensional object, and the time duration of sponsorship.

In at least one embodiment, the method 300 includes step 360 of the user submitting or uploading one or more images to the host website. The images can be any digital image from a variety of sources including, but not limited to, any social networking site. For example, the image could be uploaded from MYSPACE, FACEBOOK, LINKED IN or TWITTER. In some embodiments the host website acquires the image from the social networking site.

In at least one embodiment, the method 300 includes step 370 of assembling or arranging a mosaic from the images provided by the users into the advertising image. After all of the available portions or sections of the advertising image have been sold and all the images have been uploaded, the images are arranged into a mosaic creating the advertising image, which can be attached to a three-dimensional object.

With reference to FIG. 4, one or more mosaic format advertising images 20 can cover any or all portions of the three-dimensional object 10. In some embodiments the advertising image 20 is a full body vehicle wrap which covers substantially the entire body of the vehicle 10 including the hood, roof, trunk lid, side panels, quarter panels, and doors. In at least one alternative embodiment, the advertising image 20 can even be positioned on the hubcaps or wheel covers of a vehicle 10.

The advertising image 20 is a mosaic composed of a plurality of images 22 assembled or arranged in either a random or pre-defined configuration. The mosaic of assembled images can form a mark, logo, shape, word, or a larger image. When the mosaic 20 is viewed close-up, the individual images 22 uploaded by the users can be viewed. When the mosaic 20 is viewed from a distance, the individual images 22 create a larger image.

The individual images 22 can be arranged by many different methods including, but not limited to, commercial software, randomly, arrangement by the advertiser or sponsor selection or preference, and arrangement by user selection or preference. As stated above, the arrangement of the individual images 22 in the advertising image 20 can be determined by user selection.

In at least one embodiment, the user can select the location of the individual image 22 when the user purchases a sponsorship and uploads one or more images 22. The cost of the sponsorship can vary depending upon the location selected by the user.

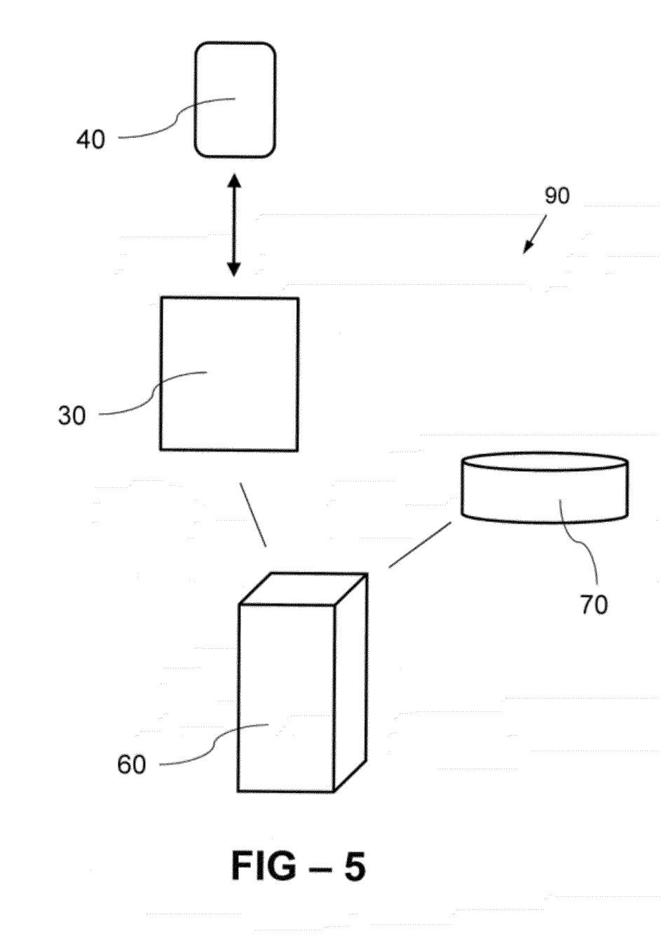

With reference to FIG. 5, an advertisement system 90 can include a host website 30, and web or internet server 60, and a database 70. The web or internet server 60 can host the host website 30 and can include the database 70. A user can access the host website 30 with any internet capable device 40 including a personal computer, a smart phone, or a cellular telephone. The user can upload a digital image, such as an individual image 22 in FIG. 4, from any location, including any social networking site. In some embodiments, the host Website 30 can access a social networking site and acquire the image from the social networking site. The host website 30 can also display a visual advertising image and a virtual three-dimensional object with the virtual advertising image so that users can view their sponsorship and the location of their individual images 22.

Users can view the virtual advertising images before, during, and after the sponsorship period and alter the advertising image on the physical three-dimensional object has been replaced or removed. The web or internet server 50 can include all of the software required to assemble the mosaic into an advertising image from the plurality of individual images provided by the plurality of users. The web or internet server 60 can also include all of the software required to generate the advertising image.

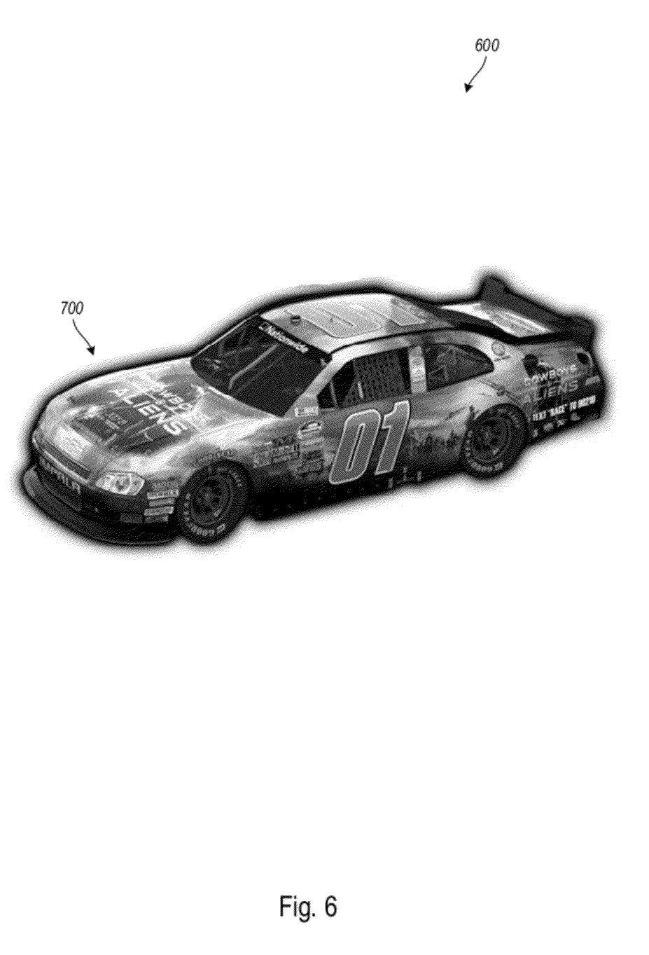

With reference to FIG. 6, the three-dimensional object depicted is a racecar 600. As discussed above, the three dimensional object can be one of many known objects, such as a racecar, and so forth, or a two-dimensional object such as is generally a billboard. The hood 700 of the racecar 600 includes a mosaic (20 in FIG. 4) of assembled images (22 if FIG. 4) in the form of a new movie release advertisement and promotion. As such, racecar fans or the like who wish to be a part of the racecar sponsorship and advertisement are enabled to fractionally sponsor the larger advertising image, such as the one shown for a new movie release advertisement and promotion.

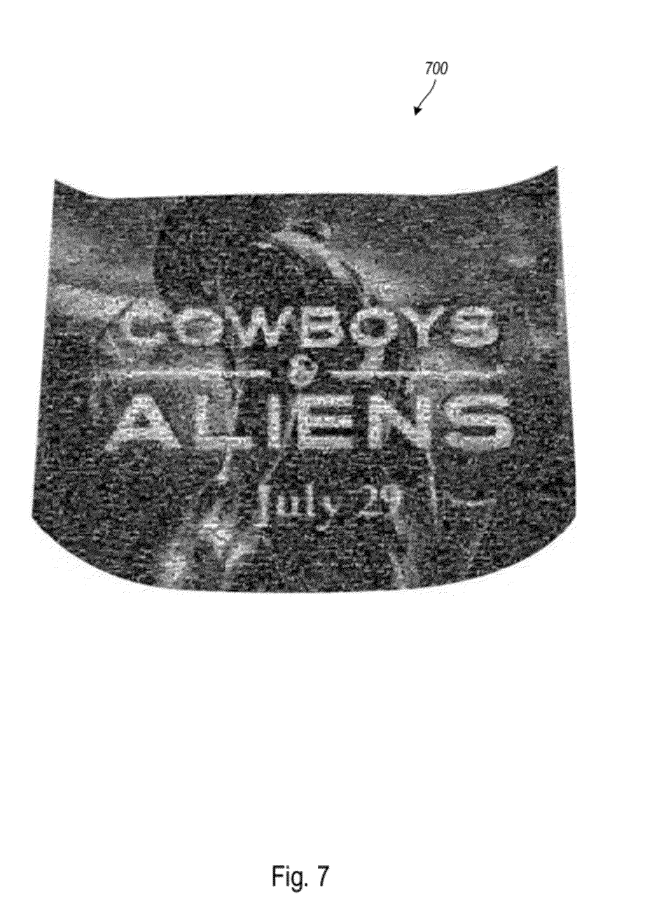

With reference to FIG. 7, a close up view of the hood 700 of the racecar 600 is illustrated. As such, one can observe the overall new movie release advertisement and promotion as an artistic mosaic rendering of thousands and thousands of individual images that are provided as described above as part of the sponsorship or endorsement.

By way of example, a movie production studio can allow users of a social networking site such as Facebook to “like” the new movie being promoted, and then by virtue of doing so, be a part of the overall photo mosaic created by the movie production studio to be used as the racecar advertisement, such as a vehicle wrap or panel. In various embodiments, the participation in such a promotion can be with or without a fee to the individual participating.

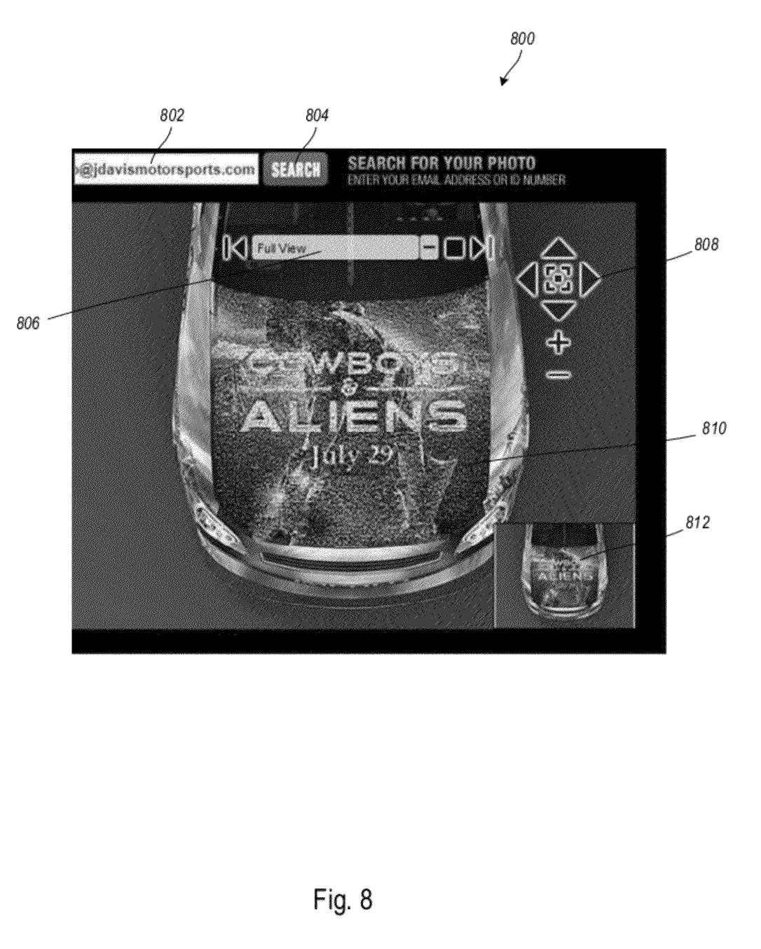

With reference to FIG. 8, an image search screen 800 is illustrated, illustrating, in particular, the mosaic advertising image 810 in searchable form to identify one or more individual images that make up the mosaic advertising image 810. The image search screen 800 can be provided by the host website 30, for example, hosted on internet server 60, stored in database 70, and displayed in the form of an internet web page, and thereby accessible though any internet capable device 40 including a personal computer, a smart phone, or a cellular telephone.

By way of example, the user of any internet capable device 40 including a personal computer, a smart phone, or a cellular telephone can access the website hosted by the host website 30. The user can enter an e-mail address, for example, or other identifying code or the like, into ID field 802. The user can then select the search button 804 to commence the search for one or more images of the user.

The user can manipulate the displayed screens with navigation and redirection buttons 806, 808. The redirection buttons 806, 808 allow a user to change to full screen move in any direction on the larger image, zoom in and zoom out, and so forth.

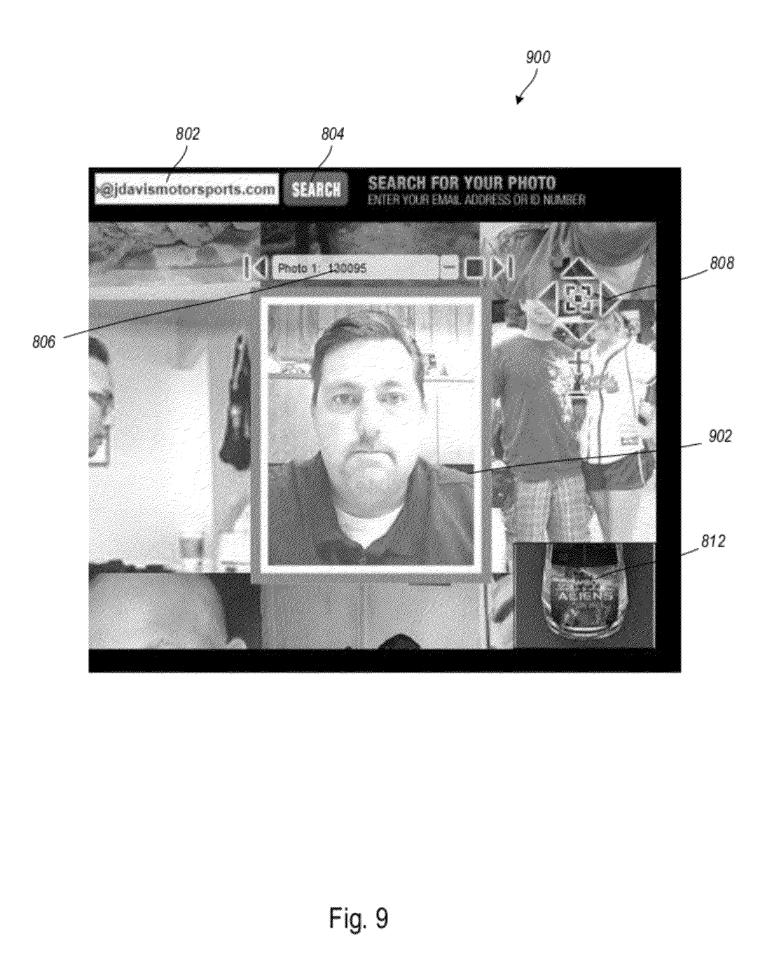

With reference to FIG. 9, a image search screen 900 is illustrated, illustrating, in particular, an individual image 902 that is one of many used to create the overall mosaic advertising image 810 depicted in FIGS. 7 and 8.

A picture-in-picture window 812 allows a user to see where within the larger mosaic advertising image 810 an individual image is located. As depicted in FIG. 8, where no individual image has been searched, the full image is displayed. As depicted in FIG. 9, depicting and individual image 902 that is the result of a user search, the picture-in-picture window 812 can show with a white box outline where in the larger mosaic advertising image 810 the individual image 902 is located relevant to the remainder of the mosaic advertising image 810.

With reference to FIG. 10, a mosaic advertising image 1000 in the form of a billboard advertisement is shown. The billboard advertisement 1000 is generally a two-dimensional object. As with the figures previously discussed, the billboard advertisement 1000 is made up of thousands in individual images, such as the three displayed to the left. The persons in those individual photos either paid a fee for such an advertisement, or were otherwise participants in another's advertisement, such as being a fan of, or “liking” the overall promoter of the advertisement. In at least one embodiment, the users provided the individual images through a social networking site to the creator of the overall mosaic image.

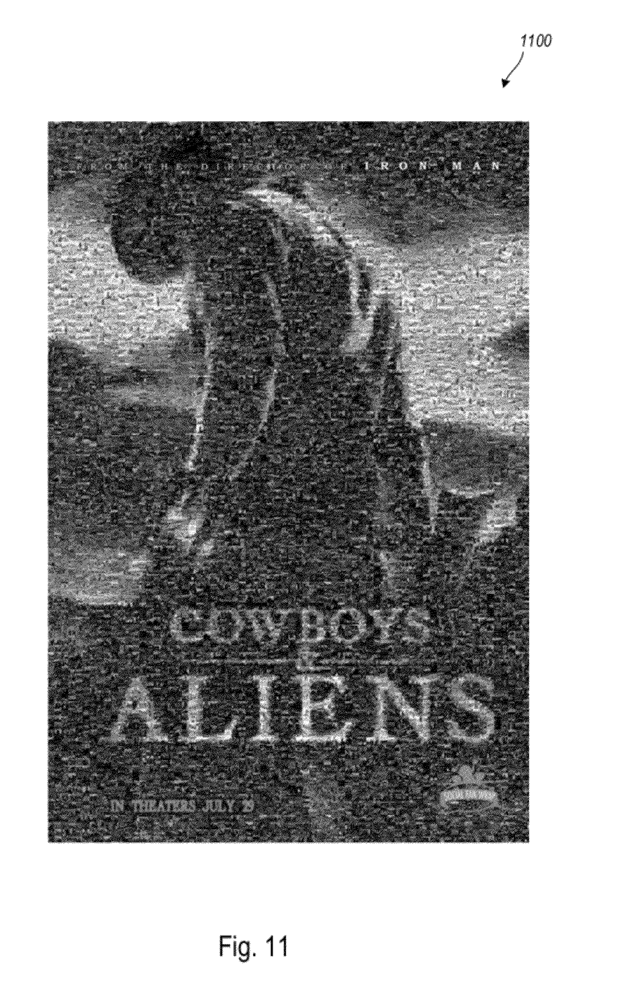

With reference to FIG. 11, a mosaic advertising image 1100 in the form of a movie poster advertisement is shown. The movie poster advertisement 1100 is generally a two-dimensional object. As with the figures previously discussed, the movie poster advertisement 1100 is made up of thousands in individual images, such as the three displayed to the left. In at least one embodiment, the users provided the individual images through a social networking site to the creator of the overall mosaic image.

It is to be understood that the disclosure teaches just one example of the illustrative embodiment and that many variations of the technology described herein can easily be devised by those skilled in the art after reading this disclosure and that the scope of the technology described herein is to be determined by the claims.

What is claimed is:

1. A method for creating an advertising image, the method comprising:
soliciting a plurality of users to each provide at least one image from a social networking site;
assembling a mosaic from images provided by the plurality of users into an advertising image; and
attaching the advertising image to a two-dimensional or three-dimensional object.

2. The method for creating an advertising image of claim 1, further comprising:
accessing, by a user, a host website where the user can select the three-dimensional object to sponsor; and
selecting, by the user, the two-dimensional or three-dimensional object to sponsor.

3. The method for creating an advertising image of claim 2, further comprising:
selecting, by the user, an advertising image to sponsor on the two-dimensional or three-dimensional object.

4. The method for creating an advertising image of claim 2, further comprising:
selecting, by the user, a number of advertising images greater than one to submit to sponsor on two-dimensional or three-dimensional object.

5. The method for creating an advertising image of claim 2, further comprising:
remitting the payment, by the user, for the sponsorship.

6. The method for creating an advertising image of claim 2, further comprising:
uploading, by the user, at least one image from a social networking website to the host website.

7. The method for creating an advertising image of claim 1, wherein the two-dimensional or three-dimensional object comprises a racecar.

8. The method for creating an advertising image of claim 1, wherein the two-dimensional or three-dimensional object comprises a billboard.

9. The method for creating an advertising image of claim 1, wherein use of the at least one image from a social networking site from the plurality of users creates an advertising platform based on social media, and wherein the resulting mosaic advertising image attached to the three-dimensional object provides actual participation by the user in the advertisement.

10. The method for creating an advertising image of claim 3, further comprising:
providing the user a means at the host website by which the advertising image selected by the user is searchable within the mosaic and viewable online by the user at the host website.

11. A method for creating an advertising image, the method comprising:
soliciting a plurality of users to each provide at least one image from a social networking site;
collecting a payment from each user submitting an image;
assembling a mosaic from images provided by the users into an advertising image;
arranging the advertising image to be placed upon a two-dimensional or three-dimensional object; and
attaching the advertising image to the two-dimensional or three-dimensional object.

12. The method for creating an advertising image of claim 11, further comprising:
accessing, by a user, a host website where the user can select the two-dimensional or three-dimensional object to sponsor; and
selecting, by the user, the two-dimensional or three-dimensional object to sponsor.

13. The method for creating an advertising image of claim 12, further comprising:
selecting, by the user, an advertising image to sponsor on the two-dimensional or three-dimensional object.

14. The method for creating an advertising image of claim 12, further comprising:
selecting, by the user, a number of advertising images greater than one to submit to sponsor on the two-dimensional or three-dimensional object.

15. The method for creating an advertising image of claim 12, further comprising:
remitting the payment, by the user, for the sponsorship.

16. The method for creating an advertising image of claim 12, further comprising:
uploading, by the user, at least one image from a social networking website to the host website.

17. The method for creating an advertising image of claim 11, wherein use of the at least one image from a social networking site from the plurality of users creates an advertising platform based on social media, and wherein the resulting mosaic advertising image attached to the three-dimensional object provides actual participation by the user in the advertisement.

18. The method for creating an advertising image of claim 13, further comprising:
providing the user a means at the host website by which the advertising image selected by the user is searchable within the mosaic and viewable online by the user at the host website.

19. A method for creating an advertising image, the method comprising:
soliciting a plurality of users to each provide at least one image from a social networking site;
collecting a payment from each user submitting an image;
assembling a mosaic from images provided by the users into an advertising image;
arranging the advertising image to be placed upon a two-dimensional or three-dimensional object;
attaching the advertising image to the two-dimensional or three-dimensional object;
accessing, by a user, a host website where the user can select the two-dimensional or three-dimensional object to sponsor;
selecting, by the user, the two-dimensional or three-dimensional object to sponsor;
selecting, by the user, an advertising image to sponsor on the two-dimensional or three-dimensional object;
selecting, by the user, a number of advertising images greater than one to submit to sponsor on the two-dimensional or three-dimensional object;
remitting the payment, by the user, for the sponsorship; and
uploading, by the user, at least one image from a social networking website to the host website;
wherein use of the at least one image from a social networking site from the plurality of users creates an advertising platform based on social media, and wherein the resulting mosaic advertising image attached to the two-dimensional or three-dimensional object provides actual participation by the user in the advertisement.

20. The method for creating an advertising image of claim 19, further comprising:
providing the user a means at the host website by which the advertising image selected by the user is searchable within the mosaic and viewable online by the user at the host website.
